(19) United States
(12) Patent Application Publication
(10) Pub. No.: US 2013/0015304 A1
(43) Pub. Date: Jan. 17, 2013

(54) Foldable bottom bracket device for stroller

(71) Applicant: Way-Hong Chen, Taipei (TW)

(72) Inventor: Way-Hong Chen, Taipei (TW)

(21) Appl. No.: 13/181,581

(22) Filed: Jul. 13, 2011

(51) Int. Cl. F16M 13/02

(52) U.S. Cl. 248/205.1

(57) ABSTRACT

A foldable bottom bracket device for a stroller includes a base unit having a bottom bracket, a support unit pivotally connected with the base unit, and a locking unit rotatably mounted on the base unit and detachably locked onto the support unit. The support unit includes two support rods each pivotally connected with the bottom bracket, and two limit rods each pivotally connected with the bottom bracket. The locking unit includes a rotation cover rotatably mounted on the bottom bracket and having two locking hooks detachably locked onto the limit rods respectively. Thus, the user only needs to rotate the rotation cover to detach the locking hooks from the limit rods to release the limit rods from the bottom bracket to unlock the support unit so that the bottom bracket device is unlocked and folded easily and quickly.

### BACKGROUND OF THE INVENTION

1. Field of the Invention

The present invention relates to a stroller and, more particularly, to a foldable bottom bracket device for a stroller.

2. Description of the Related Art

A conventional foldable bottom bracket device for a stroller comprises a bottom bracket, four support rods pivotally mounted on the bottom bracket, and two locking members mounted on the bottom bracket and detachably locked onto two of the support rods to releasably lock the support rods onto the bottom bracket. Each of the two locking members is pressed by a user to detach from the support rods respectively so as to unlock and fold the support rods. However, the user has to press the two locking members simultaneously so as to unlock and fold the support rods, thereby causing inconvenience to the user. In addition, the support rods are not folded easily and quickly by pressing the two locking members.

### BRIEF SUMMARY OF THE INVENTION

In accordance with the present invention, there is provided a foldable bottom bracket device for a stroller, comprising a base unit, a support unit pivotally connected with the base unit, and a locking unit rotatably mounted on the base unit and detachably locked onto the support unit to releasably lock the support unit onto the base unit.

The base unit includes a bottom bracket. The support unit includes two support rods each pivotally connected with the bottom bracket of the base unit, and two limit rods each pivotally connected with the bottom bracket of the base unit. The locking unit includes a rotation cover rotatably mounted on the bottom bracket of the base unit and having a periphery provided with two locking hooks detachably locked onto the two limit rods of the support unit respectively to releasably lock the two limit rods of the support unit onto the bottom bracket of the base unit, and a drive handle mounted on the rotation cover to rotate the rotation cover relative to the bottom bracket of the base unit and to move the two locking hooks of the rotation cover relative to the two limit rods of the support unit. The base unit further includes two upright posts mounted on a top of the bottom bracket. The rotation cover of the locking unit has a bottom provided with two slideways slidably mounted on the two upright posts of the base unit respectively. The bottom bracket of the base unit has a side provided with two mounting recesses. Each of the two support rods of the support unit is pivotally mounted in a respective one of the two mounting recesses of the bottom bracket by a pivot pin. The bottom bracket of the base unit has a middle portion provided with a through hole. The two limit rods of the support unit are pivotally mounted in the through hole of the bottom bracket. The two limit rods of the support unit are pivotally connected with each other by a fastening pin. Each of the two limit rods of the support unit has an end portion provided with a semi-circular connecting head. The connecting heads of the two limit rods are juxtaposed to each other and are pivotally connected with each other by the fastening pin. Each of the two upright posts of the base unit has an interior provided with a fixing hole for mounting a guide pin. The rotation cover of the locking unit has a surface provided with two elongate guide slots each connected to a respective one of the slideways. Each of the two guide slots of the rotation cover is slidably mounted on the guide pin of a respective one of the two upright posts to guide movement of the rotation cover of the locking unit relative to the bottom bracket of the base unit. The rotation cover of the locking unit has a top provided with a mounting seat, and the drive handle of the locking unit is pivotally mounted on the mounting seat of the rotation cover by a fixing pin. The drive handle of the locking unit has an interior provided with a pivot hole pivotally mounted on the fixing pin. Each of the two locking hooks of the rotation cover has a side provided with a guide ramp corresponding to a respective one of the two limit rods of the support unit. The locking unit further includes two elastic members each mounted in a respective one of the slideways of the rotation cover and each biased between a respective one of the upright posts of the base unit and the rotation cover of the locking unit so that the rotation cover of the locking unit has an automatically restoring function.

According to the primary advantage of the present invention, the user only needs to rotate the rotation cover of the locking unit to detach the two locking hooks of the rotation cover from the two limit rods of the support unit respectively to release the two limit rods of the support unit from the bottom bracket of the base unit so as to unlock the support unit so that the bottom bracket device of the stroller is unlocked and folded easily and quickly.

According to another advantage of the present invention, each of the two locking hooks of the rotation cover is pushed toward the respective limit rod of the support unit by the elastic force of the respective elastic member so that the two locking hooks of the rotation cover are locked onto the two limit rods of the support unit respectively to lock the two limit rods of the support unit onto the bottom bracket of the base unit so as to lock the support unit exactly and stably.

According to a further advantage of the present invention, the rotation cover of the locking unit has an automatically restoring function by action of the two elastic members so that the two locking hooks of the rotation cover are locked onto the two limit rods of the support unit easily and conveniently.

According to a further advantage of the present invention, each of the two locking hooks of the rotation cover has a guide ramp corresponding to the respective limit rod of the support unit so that each of the two locking hooks of the rotation cover is locked onto the respective limit rod of the support unit easily and quickly by guidance of the guide ramp.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially perspective view of a foldable bottom bracket device for a stroller in accordance with the preferred embodiment of the present invention.

FIG. 2 is an exploded perspective view of the foldable bottom bracket device for a stroller as shown in FIG. 1.

FIG. 3 is a perspective view of a base unit of the foldable bottom bracket device for a stroller as shown in FIG. 2.

FIG. 4 is a front cross-sectional view of the foldable bottom bracket device for a stroller as shown in FIG. 1.

FIG. 5 is a top operational view of the foldable bottom bracket device for a stroller as shown in FIG. 1.

FIG. 6 is a cross-sectional view of the foldable bottom bracket device for a stroller as shown in FIG. 5.

FIG. 7 is a perspective folded view of the foldable bottom bracket device for a stroller as shown in FIG. 1.

### DETAILED DESCRIPTION OF THE INVENTION

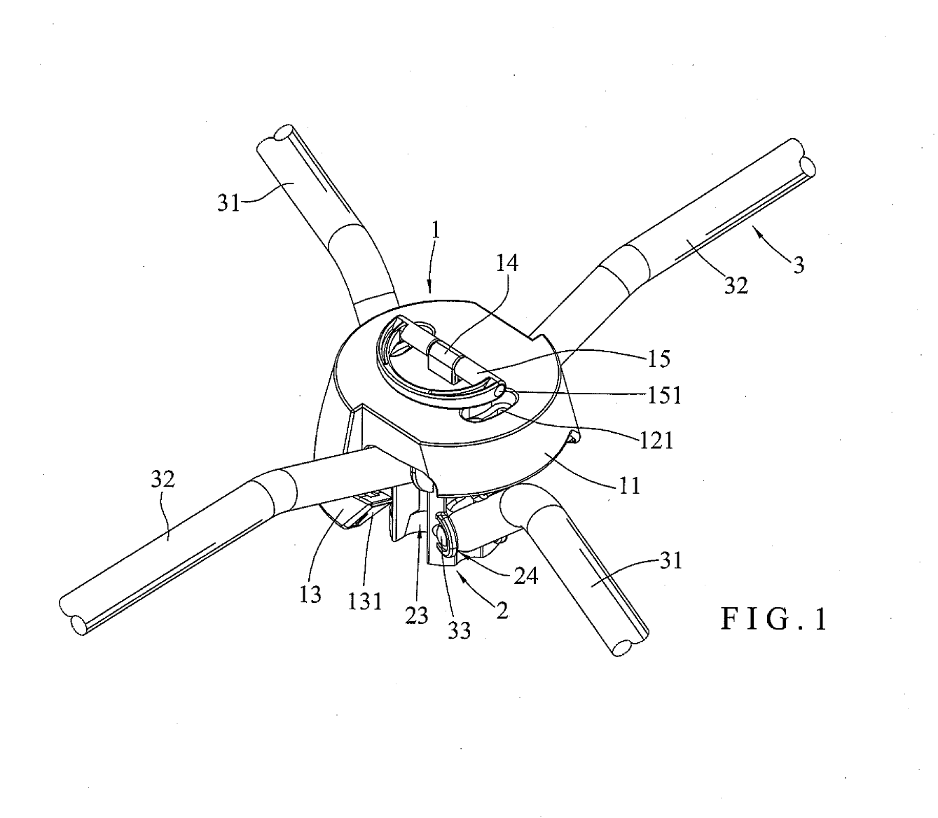

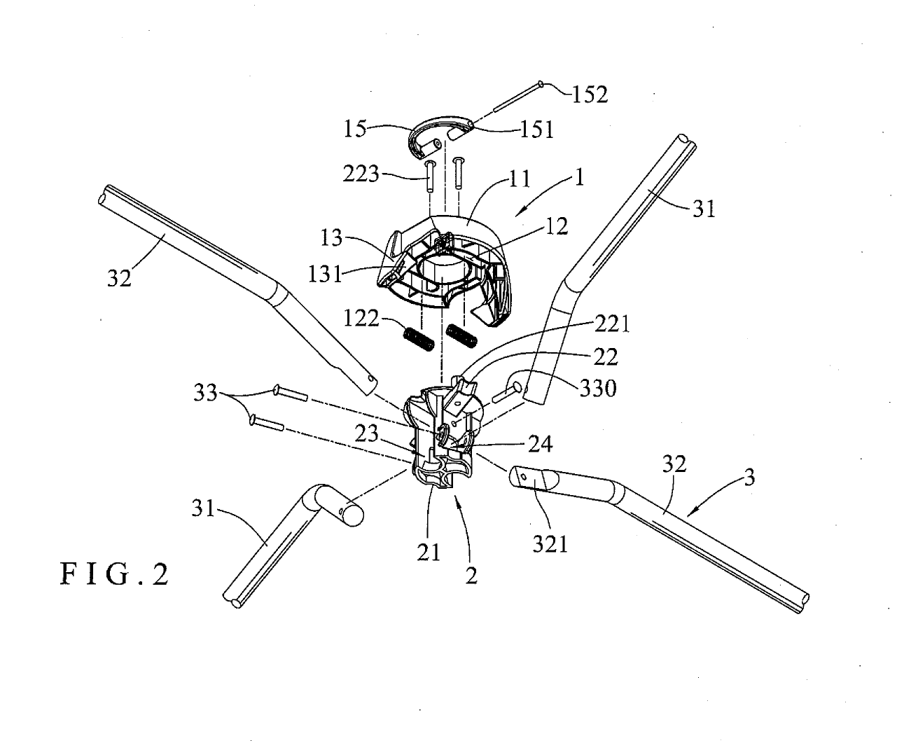

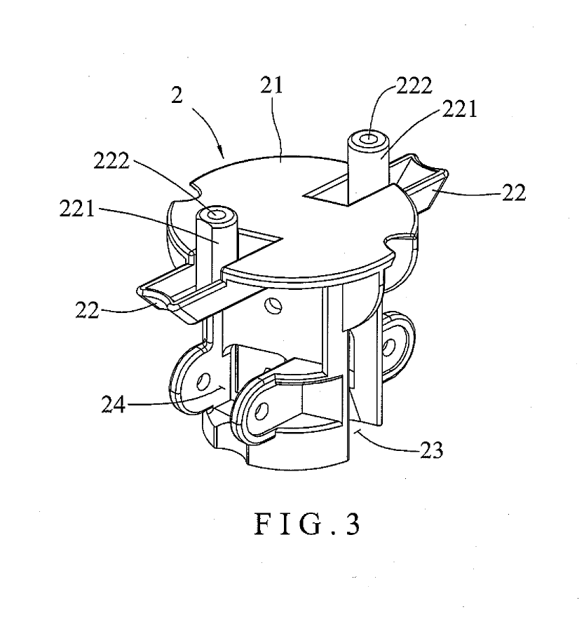

Referring to the drawings and initially to FIGS. 1-6, a foldable bottom bracket device for a stroller in accordance with the preferred embodiment of the present invention comprises a base unit 2, a support unit 3 pivotally connected with the base unit 2, and a locking unit 1 rotatably mounted on the base unit 2 and detachably locked onto the support unit 3 to releasably lock the support unit 3 onto the base unit 2.

The base unit 2 includes a bottom bracket 21, and two upright posts 221 mounted on a top of the bottom bracket 21. The bottom bracket 21 of the base unit 2 has a peripheral wall provided with two extension seats 22 to support the two upright posts 221. The bottom bracket 21 of the base unit 2 has a middle portion provided with a through hole 23. The bottom bracket 21 of the base unit 2 has a side provided with two mounting recesses 24. Each of the two upright posts 221 of the base unit 2 has an interior provided with a fixing hole 222 for mounting a guide pin 223.

The support unit 3 includes two support rods 31 each pivotally connected with the bottom bracket 21 of the base unit 2, and two limit rods 32 each pivotally connected with the bottom bracket 21 of the base unit 2. Each of the two support rods 31 of the support unit 3 is pivotally mounted in a respective one of the two mounting recesses 24 of the bottom bracket 21 by a pivot pin 33. The two limit rods 32 of the support unit 3 are pivotally mounted in the through hole 23 of the bottom bracket 21. The two limit rods 32 of the support unit 3 are pivotally connected with each other by a fastening pin 330. Each of the two limit rods 32 of the support unit 3 has an end portion provided with a semi-circular connecting head 321. The connecting heads 321 of the two limit rods 32 are juxtaposed to each other and are pivotally connected with each other by the fastening pin 330.

The locking unit 1 includes a rotation cover 11 rotatably mounted on the bottom bracket 21 of the base unit 2 and having a periphery provided with two locking hooks 13 detachably locked onto the two limit rods 32 of the support unit 3 respectively to releasably lock the two limit rods 32 of the support unit 3 onto the bottom bracket 21 of the base unit 2, and a drive handle 15 mounted on the rotation cover 11 to rotate the rotation cover 11 relative to the bottom bracket 21 of the base unit 2 and to move the two locking hooks 13 of the rotation cover 11 relative to the two limit rods 32 of the support unit 3.

The rotation cover 11 of the locking unit 1 has a bottom provided with two slideways 12 slidably mounted on the two upright posts 221 of the base unit 2 respectively. The rotation cover 11 of the locking unit 1 has a surface provided with two elongate guide slots 121 each connected to a respective one of the slideways 12. Each of the two guide slots 121 of the rotation cover 11 has a substantially arc-shaped profile and has a dimension smaller than that of the respective slideway 12. Each of the two guide slots 121 of the rotation cover 11 is slidably mounted on the guide pin 223 of a respective one of the two upright posts 221 to guide movement of the rotation cover 11 of the locking unit 1 relative to the bottom bracket 21 of the base unit 2. Each of the two guide slots 121 of the rotation cover 11 is located above the respective slideway 12.

The rotation cover 11 of the locking unit 1 has a top provided with a mounting seat 14, and the drive handle 15 of the locking unit 1 is pivotally mounted on the mounting seat 14 of the rotation cover 11 by a fixing pin 152. The drive handle 15 of the locking unit 1 has an interior provided with a pivot hole 151 pivotally mounted on the fixing pin 152. Each of the two locking hooks 13 of the rotation cover 11 has a side provided with a guide ramp 131 corresponding to a respective one of the two limit rods 32 of the support unit 3.

The locking unit 1 further includes two elastic members 122 each mounted in a respective one of the slideways 12 of the rotation cover 11 and each biased between a respective one of the upright posts 221 of the base unit 2 and the rotation cover 11 of the locking unit 1 so that the rotation cover 11 of the locking unit 1 has an automatically restoring function. Thus, each of the two locking hooks 13 of the rotation cover 11 is pushed toward a respective one of the two limit rods 32 of the support unit 3 by an elastic force of a respective one of the two elastic members 122.

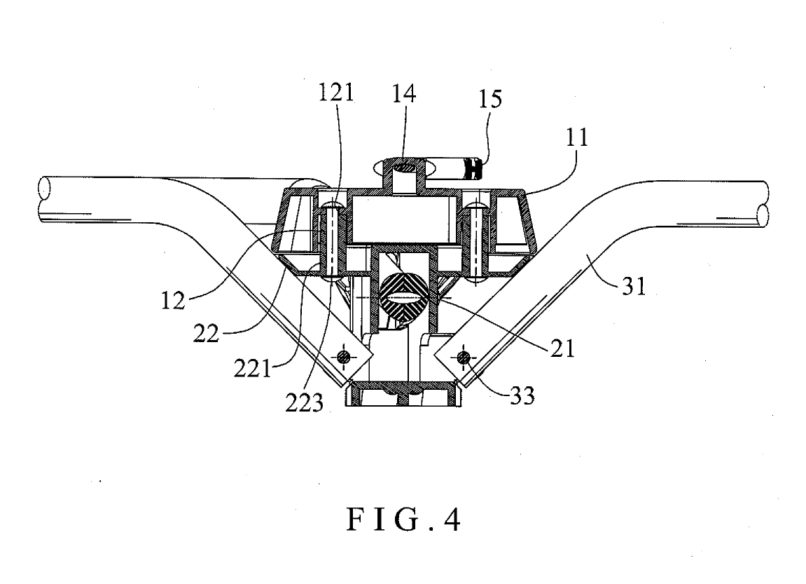

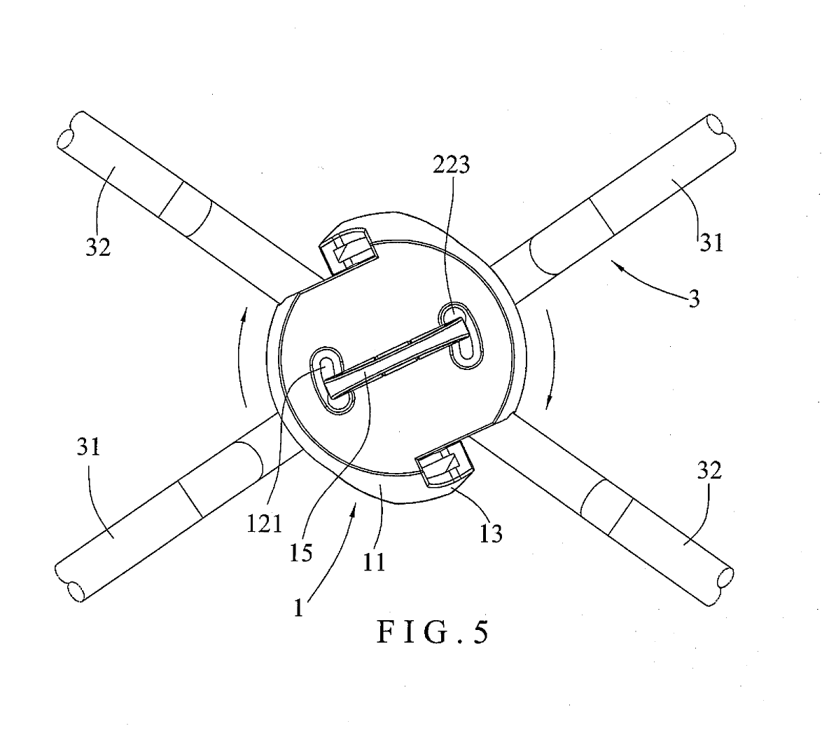

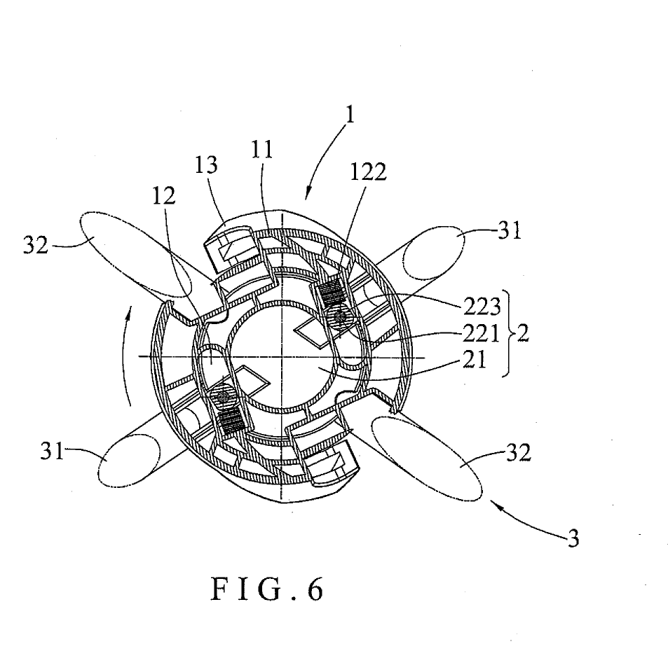

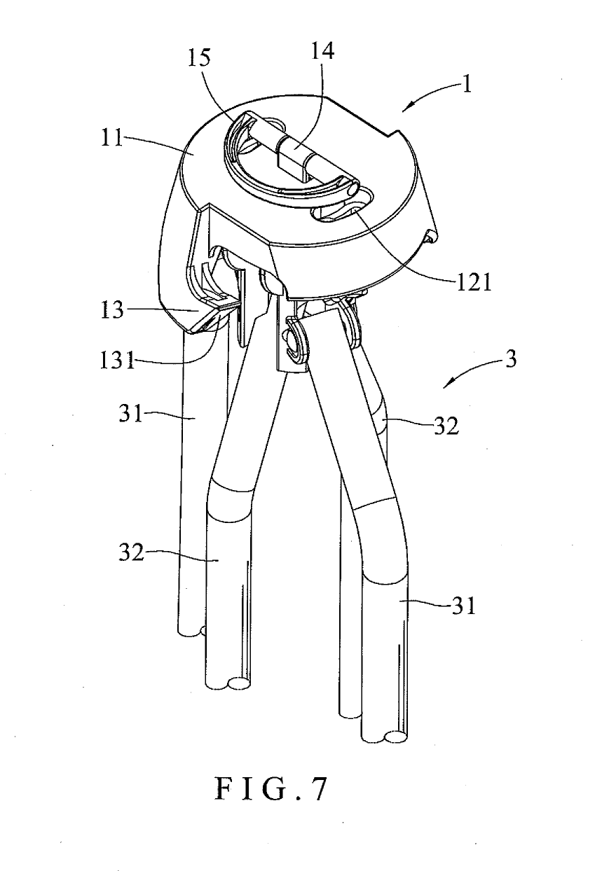

In operation, referring to FIGS. 4-7 with reference to FIGS. 1-3, each of the two locking hooks 13 of the rotation cover 11 is pushed toward the respective limit rod 32 of the support unit 3 by the elastic force of the respective elastic member 122 so that the two locking hooks 13 of the rotation cover 11 are locked onto the two limit rods 32 of the support unit 3 respectively as shown in FIG. 1 to releasably lock the two limit rods 32 of the support unit 3 onto the bottom bracket 21 of the base unit 2 so as to lock the support unit 3. When the drive handle 15 of the locking unit 1 is rotated by a user, the rotation cover 11 of the locking unit 1 rotated relative to the bottom bracket 21 of the base unit 2 so that the two locking hooks 13 of the rotation cover 11 are moved to detach from the two limit rods 32 of the support unit 3 respectively as shown in FIGS. 5 and 6 to release the two limit rods 32 of the support unit 3 from the bottom bracket 21 of the base unit 2 so as to unlock the support unit 3. At this time, each of the two elastic members 122 is compressed toward the respective upright post 221 of the base unit 2 as shown in FIG. 6 so that the rotation cover 11 of the locking unit 1 has an automatically restoring function. Thus, when the drive handle 15 of the locking unit 1 is pulled upward, the two support rods 31 and the two limit rods 32 of the support unit 3 are pivoted downward as shown in FIG. 7 so as to fold the support unit 3.

Accordingly, the user only needs to rotate the rotation cover 11 of the locking unit 1 to detach the two locking hooks 13 of the rotation cover 11 from the two limit rods 32 of the support unit 3 respectively to release the two limit rods 32 of the support unit 3 from the bottom bracket 21 of the base unit 2 so as to unlock the support unit 3 so that the bottom bracket device of the stroller is unlocked and folded easily and quickly. In addition, each of the two locking hooks 13 of the rotation cover 11 is pushed toward the respective limit rod 32 of the support unit 3 by the elastic force of the respective elastic member 122 so that the two locking hooks 13 of the rotation cover 11 are locked onto the two limit rods 32 of the support unit 3 respectively to lock the two limit rods 32 of the support unit 3 onto the bottom bracket 21 of the base unit 2 so as to lock the support unit 3 exactly and stably. Further, the rotation cover 11 of the locking unit 1 has an automatically restoring function by action of the two elastic members 122 so that the two locking hooks 13 of the rotation cover 11 are locked onto the two limit rods 32 of the support unit 3 easily and conveniently. Further, each of the two locking hooks 13 of the rotation cover 11 has a guide ramp 131 corresponding to the respective limit rod 32 of the support unit 3 so that each of the two locking hooks 13 of the rotation cover 11 is locked onto the respective limit rod 32 of the support unit 3 easily and quickly by guidance of the guide ramp 131.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A foldable bottom bracket device for a stroller, comprising:
a base unit;
a support unit pivotally connected with the base unit; and
a locking unit rotatably mounted on the base unit and detachably locked onto the support unit to releasably lock the support unit onto the base unit.

2. The foldable bottom bracket device for a stroller of claim 1, wherein
the base unit includes a bottom bracket;
the support unit includes:
two support rods each pivotally connected with the bottom bracket of the base unit; and
two limit rods each pivotally connected with the bottom bracket of the base unit;
the locking unit includes:
a rotation cover rotatably mounted on the bottom bracket of the base unit and having a periphery provided with two locking hooks detachably locked onto the two limit rods of the support unit respectively to releasably lock the two limit rods of the support unit onto the bottom bracket of the base unit; and
a drive handle mounted on the rotation cover to rotate the rotation cover relative to the bottom bracket of the base unit and to move the two locking hooks of the rotation cover relative to the two limit rods of the support unit.

3. The foldable bottom bracket device for a stroller of claim 2, wherein
the base unit further includes two upright posts mounted on a top of the bottom bracket;
the rotation cover of the locking unit has a bottom provided with two slideways slidably mounted on the two upright posts of the base unit respectively.

4. The foldable bottom bracket device for a stroller of claim 3, wherein the bottom bracket of the base unit has a peripheral wall provided with two extension seats to support the two upright posts.

5. The foldable bottom bracket device for a stroller of claim 2, wherein
the bottom bracket of the base unit has a side provided with two mounting recesses;
each of the two support rods of the support unit is pivotally mounted in a respective one of the two mounting recesses of the bottom bracket by a pivot pin.

6. The foldable bottom bracket device for a stroller of claim 2, wherein
the bottom bracket of the base unit has a middle portion provided with a through hole;
the two limit rods of the support unit are pivotally mounted in the through hole of the bottom bracket.

7. The foldable bottom bracket device for a stroller of claim 6, wherein the two limit rods of the support unit are pivotally connected with each other by a fastening pin.

8. The foldable bottom bracket device for a stroller of claim 7, wherein
each of the two limit rods of the support unit has an end portion provided with a semi-circular connecting head;
the connecting heads of the two limit rods are juxtaposed to each other and are pivotally connected with each other by the fastening pin.

9. The foldable bottom bracket device for a stroller of claim 3, wherein
each of the two upright posts of the base unit has an interior provided with a fixing hole for mounting a guide pin;
the rotation cover of the locking unit has a surface provided with two elongate guide slots each connected to a respective one of the slideways;
each of the two guide slots of the rotation cover is slidably mounted on the guide pin of a respective one of the two upright posts to guide movement of the rotation cover of the locking unit relative to the bottom bracket of the base unit.

10. The foldable bottom bracket device for a stroller of claim 2, wherein
the rotation cover of the locking unit has a top provided with a mounting seat;
the drive handle of the locking unit is pivotally mounted on the mounting seat of the rotation cover by a fixing pin.

11. The foldable bottom bracket device for a stroller of claim 10, wherein the drive handle of the locking unit has an interior provided with a pivot hole pivotally mounted on the fixing pin.

12. The foldable bottom bracket device for a stroller of claim 2, wherein each of the two locking hooks of the rotation cover has a side provided with a guide ramp corresponding to a respective one of the two limit rods of the support unit.

13. The foldable bottom bracket device for a stroller of claim 3, wherein the locking unit further includes two elastic members each mounted in a respective one of the slideways of the rotation cover and each biased between a respective one of the upright posts of the base unit and the rotation cover of the locking unit so that the rotation cover of the locking unit has an automatically restoring function.

14. The foldable bottom bracket device for a stroller of claim 13, wherein each of the two locking hooks of the rotation cover is pushed toward a respective one of the two limit rods of the support unit by an elastic force of a respective one of the two elastic members.

15. The foldable bottom bracket device for a stroller of claim 9, wherein each of the two guide slots of the rotation cover has a substantially arc-shaped profile.

16. The foldable bottom bracket device for a stroller of claim 9, wherein each of the two guide slots of the rotation cover has a dimension smaller than that of the respective slideway.

17. The foldable bottom bracket device for a stroller of claim 9, wherein each of the two guide slots of the rotation cover is located above the respective slideway.
